(19) United States
(12) Patent Application Publication
(10) Pub. No.: US 2003/0178931 A1
(43) Pub. Date: Sep. 25, 2003

(54) Cathode ray tube

(76) Inventor: Yoshiro Asano, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/363,548

(22) PCT Filed: Jul. 9, 2002
(86) PCT No.: PCT/JP02/06956

(30) Foreign Application Priority Data
Jul. 13, 2001 (JP) 2001214283

(51) Int. Cl. H01J 31/00

(52) U.S. Cl. 313/477 R; 313/479

(57) ABSTRACT

A cathode ray tube which provides a favorable quality with a high contrast by reducing the reentrance of reflected electrons into a fluorescent face or stray light. The out wall of the skirt section (3B) of at least the panel section (3) of a cathode ray tube body (2) is coated with a photoabsorbent layer (10), which constitutes a cathode ray tube formed of a material with almost the same refractive index as that of the cathode ray tube body (2).

### TECHNICAL FIELD

The present invention relates to a cathode ray tube suitable for use in a projector.

### BACKGROUND ART

In a single-color cathode ray tube such as a cathode ray tube for a projection type display (projector), particularly high intensity and high contrast are required in order to display pictures of excellent quality.

When electron beams impinge upon a fluorescent screen formed on an inside surface of a panel portion of a cathode ray tube assembly, a part of the electron beams are reflected as a reflected electron beams.

Since those reflected electron beams are further reflected on the cathode ray tube assembly or the like and again impinge upon the fluorescent screen, the contrast of image is greatly deteriorated.

Further, particularly in the case where a plurality of cathode ray tubes are arranged close to each other, for example, in a television receiver which applies a projection type display (projector), light leaked from a side surface of a panel portion and from a funnel portion of the adjacent cathode ray tube affects each other and the contrast is deteriorated.

Therefore, as shown in FIG. 4, in a cathode ray tube for a projector there has been covered an outside surface of a skirt portion 53B of a panel portion 53 in a cathode ray tube assembly 52 with a black tape 60 wound around the surface.

By means of the black tape 60, light leaked from the skirt portion 53B to the outside of the cathode ray tube assembly 52 is prevented.

Accordingly, deterioration of the contrast of image in a cathode ray tube 51 can be prevented.

Also, winding tape 60 is efficient in preventing a scratch on the skirt portion 53B during a manufacturing process.

However, conventionally there has not been considered refractive indexes of a base material and adhesive material, of the tape 60.

Therefore, reflection occurs on an interface between the base material and adhesive material, and the glass constituting cathode ray tube assembly 52, whereby stray light based on the reflection impinges again upon the fluorescent screen formed on the inside surface of the front surface of the panel portion 53A.

As a result, the contrast of image fed by the cathode ray tube 51 has been deteriorated.

In order to solve the above-mentioned problems, according to the present invention, there is provided a cathode ray tube in which the excellent quality of the picture having the high contrast is obtained by reducing the re-entry of the reflected electron beams into the fluorescent screen and the stray light.

### DISCLOSURE OF THE INVENTION

In a cathode ray tube according to the present invention, a light-absorption material layer is formed to cover at least the outside surface of a skirt portion of a panel portion of a cathode ray tube assembly, and the layer is composed of material having a refractive index approximately equal to that of the cathode ray tube.

In the above-described construction of the cathode ray tube according to the present invention, since the light-absorption material layer is formed to cover at least the outside surface of the skirt portion of the panel portion of the cathode ray tube assembly, stray light reflected in the cathode ray tube and that reflected on the skirt portion are absorbed into the light-absorption material layer.

Further, since the light-absorption material layer is composed of material having a refractive index approximately equal to that of the cathode ray tube assembly, reflectance on the interface between the light-absorption material layer and cathode ray tube assembly, that is, reflectance on the outside surface of the cathode ray tube assembly is extremely reduced, thereby enabling most of the above-mentioned stray light to impinge upon the light-absorption material layer to be absorbed.

### BRIEF DESCRIPTION OF DRAWINGS

FIG. 1 is a schematic constitutional view of a cathode ray tube according to an embodiment of the present invention;

FIG. 2A is a side view showing the front surface of the cathode ray tube of FIG. 1;

FIG. 2B is a side view showing the side of the cathode ray tube of FIG. 1;

FIGS. 3A and 3B are views to be used for explaining reflection on a light-absorption material layer is described; and

FIG. 4 is a side view of a conventional cathode ray tube for a projector.

### BEST MODE FOR CARRYING OUT THE INVENTION

A cathode ray tube according to the present invention is the cathode ray tube, in which the light-absorption material layer is formed to cover at least the outside surface of the skirt portion of the panel portion of the cathode ray tube assembly and is composed of material having a refractive index approximately equal to that of the cathode ray tube assembly.

Further, according to the present invention the light-absorption material layer in the above described cathode ray tube is formed of a coating film.

Further, according to the present invention the light-absorption material layer in the above described cathode ray tube is formed of adhesive tape whose base material or adhesive material has a refractive index approximately equal to that of the cathode ray tube assembly.

Furthermore, according to the present invention the light-absorption material layer in the above described cathode ray tube is further formed on the outside surface of the front surface other than an effective screen area of the panel portion of the cathode ray tube assembly.

Furthermore, according to the present invention the light-absorption material layer in the above described cathode ray tube is further formed on the outside surface of a funnel portion of the cathode ray tube assembly.

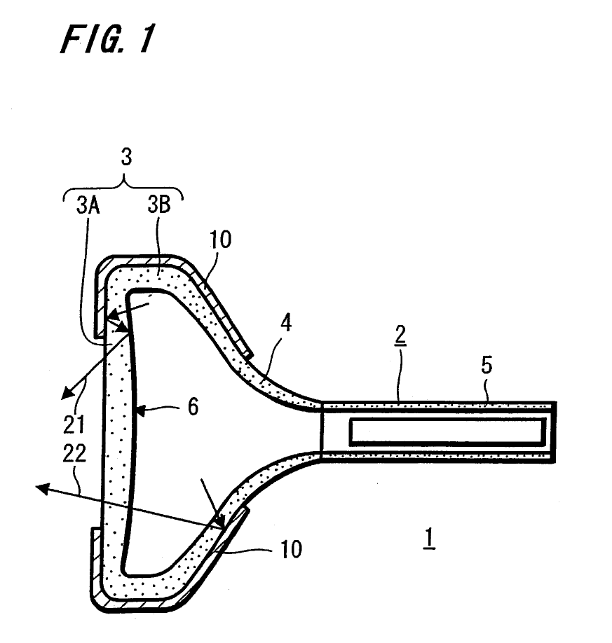

FIG. 1 is a schematic constitutional view (sectional view) of the cathode ray tube according to an embodiment of the present invention.

A cathode ray tube 1 comprises a cathode ray tube assembly 2 which is made of glass and has a panel portion 3, a funnel portion 4 and a neck portion 5.

Then, in the cathode ray tube assembly 2 a fluorescent screen is formed on the inside surface of a front surface 3A of the panel portion 3 and an electron gun 7 is disposed in the neck portion 5.

Further, the cathode ray tube 1 is constructed as a glass deposition type cathode ray tube in which the cathode ray tube assembly 2 comprises the panel portion 3 and funnel portion 4 integrally formed.

In this embodiment, as shown in FIG. 1 a light-absorption material layer 10 is formed on the outside surface of the cathode ray tube assembly 2 particularly from the funnel portion 4 to a skirt portion 3B of the panel portion 3 and a part of the front surface 3A of the panel portion 3.

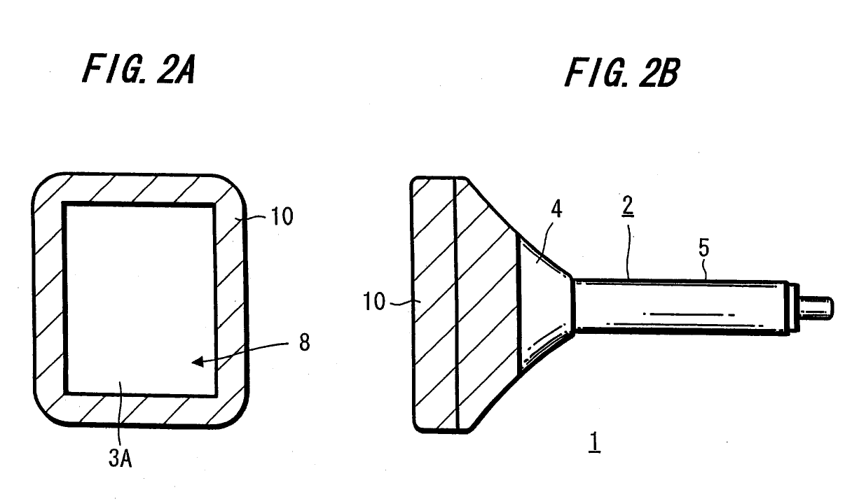

FIGS. 2A and 2B are side views of the cathode ray tube 1 in FIG. 1. FIG. 2A is a side view showing the front surface of the panel portion 3, and FIG. 2B is a side view showing the side of the cathode ray tube 1.

As shown in FIG. 2, on the front surface 3A of the panel portion 3 the light-absorption material layer 10 is formed on a frame area other than an effective screen area 8.

Here, following factors are listed as the causes of the deterioration of contrast of image in the cathode ray tube for a projector or the like: (1) stray light repeatedly reflected in the cathode ray tube assembly (glass), (2) stray light reflected on the cathode ray tube assembly (3) other factors.

Among these factors, while (2) stray light reflected on the cathode ray tube assembly causes the deterioration of contrast of image by reflecting on the cathode ray tube assembly to re-enter the fluorescent screen directly, positions at the surface on which the reflection occurs and reflectance may differ according to a construction of the cathode ray tube.

As shown in FIG. 1, in the cathode ray tube 1 according to this embodiment, (1) stray light which has repeatedly reflected in the cathode ray tube assembly (glass) is indicated by an arrow 21 and (2) stray light reflected on the cathode ray tube assembly is indicated by an arrow 22, respectively.

Then, in the cathode ray tube 1 according to this embodiment, those beams of stray light 21 and 22 are absorbed into the light-absorption material layer 10 formed to cover the outside surface of the cathode ray tube assembly 2, thereby preventing the deterioration of contrast of image.

Further in this embodiment, the light-absorption material layer 10 is formed of material having a refractive index approximately equal to that of the cathode ray tube assembly 2.

Accordingly, light reflected on the interface between the cathode ray tube assembly 2 and light-absorption material layer 10, that is, on the outside surface of the cathode ray tube assembly 2 is extremely reduced.

The following two kinds of layers may be employed as the light-absorption material layer 10.

(1) The light-absorption material layer 10 is formed of a coating film. The outside surface of the cathode ray tube assembly 2A is coated with light-absorption material to form the coating film of the light-absorption material layer 10.

(2) The light-absorption material layer 10 is formed of adhesive tape.

The light-absorption material layer 10 is formed on the outside surface of the cathode ray tube assembly 2 by attaching the adhesive tape in which adhesive material is provided on the main surface of tape base material formed of light-absorption material.

Specifically, each light-absorption material layer 10 is constructed as follows.

First, when the light-absorption material layer 10 is formed of a coating film, a refractive index of the light-absorption material is set approximately equal to a refractive index of the cathode ray tube assembly 2, for example, that of glass.

As described above, the refractive index of the light-absorption material in the coating film is set approximately equal to that of glass constituting the cathode ray tube assembly 2, whereby reflected light is reduced and stray light is absorbed.

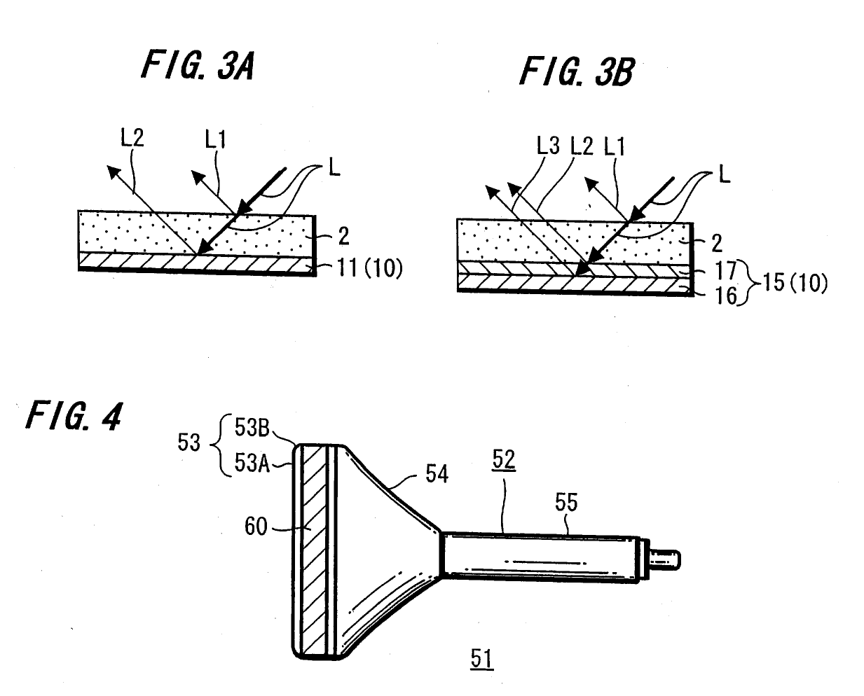

Hereupon, referring to the sectional view of FIG. 3A, there is described reflection on the light-absorption material layer 10 and on the cathode ray tube assembly 2 when the light-absorption material layer is formed of the coating film.

As shown in FIG. 3A, light L incident upon the cathode ray tube assembly 2 from inside is reflected on the surface (inside surface) of the cathode ray tube assembly 2 to generate the reflected light L1, and the light L is further reflected on the interface between the cathode ray tube assembly 2 and the light-absorption material layer 10, that is, in this case a coating film 11 to generate the reflected light L2.

As described above, when the refractive index of the coating film 11 is set approximately equal to that of the cathode ray tube assembly 2, the reflectance on the interface between the cathode ray tube assembly 2 and the coating film 11 is made extremely small and the reflected light L2 shown in the FIG. 3A is virtually reduced to nothing. Accordingly, the light L entered the cathode ray tube assembly 2 is virtually absorbed into the coating film 11.

Next, in the case where the light-absorption material layer 10 is formed of adhesive tape, a refractive index of tape base material or adhesive material of the adhesive tape is set approximately equal to a refractive index of the cathode ray tube assembly 2, for example, that of glass.

When, for example, projector panel glass (refractive index 1.56) is employed as the glass constituting cathode ray tube assembly 2, polyester black tape (refractive index 0 to 0.1), for example, is used as the tape base material, and acrylic resin (refractive index 1.5 to 1.6) is employed as the adhesive material, for example.

As described above, when the refractive index of the tape base material or that of the light absorption material in the adhesive material is set approximately equal to that of glass constituting cathode ray tube assembly 2, reflected light is reduced and stray light is absorbed.

Hereupon, referring to the sectional view of FIG. 3B, there is described reflection on the light-absorption material layer 10 and on the cathode ray tube assembly 2 when the light-absorption material layer 10 is formed of adhesive tape.

As shown in FIG. 3B, light L incident upon the cathode ray tube assembly 2 from inside is reflected on the surface (inside surface) of the cathode ray tube assembly 2 to generate the reflected light L1, and the light L is further reflected on the interface between the cathode ray tube assembly 2 and the light-absorption material layer 10, that is, in this case the adhesive material 17 of the adhesive tape 15 to generate reflected light L2. Moreover, the incident light L is reflected on the interface between the tape base material 16 and the adhesive material 17 to generate reflected light L3.

As described above, when the refractive index of the tape base material 16 of the adhesive tape 15 is set approximately equal to that of cathode ray tube assembly 2, the reflectance on the interface between the tape base material 16 of the adhesive tape 15 and the adhesive material 17 thereof is extremely reduced and the reflected light L3 shown in FIG. 3B is virtually reduced to nothing. Accordingly, the light L entered the adhesive tape 15 is virtually absorbed into the tape base material 16.

Further, as described above, when the refractive index of the adhesive material 17 of the adhesive tape 15 is set approximately equal to that of the cathode ray tube assembly 2, the reflectance on the interface between the cathode ray tube assembly 2 and the adhesive material 17 is extremely reduced and the reflected light L2 shown in the FIG. 3B is virtually reduced to nothing.

Specifically, the refractive index of the tape base material 16 of the adhesive tape 15 is set approximately equal to that of glass constituting the cathode ray tube assembly 2, whereby the reflected light can be reduced and the stray light can be absorbed into the tape base material 16. Further, the refractive index of the adhesive material 17 of the adhesive tape 15 is set approximately equal to that of glass constituting the cathode ray tube assembly 2, whereby the reflected light can be reduced.

When at least one of these tape base material 16 and adhesive material 17 of the adhesive tape 15 is selected from the material having the refractive index approximately equal to that of glass constituting cathode ray tube assembly 2, reflected light with respect to the incident light L can be reduced.

Further, if both of the tape base material 16 and the adhesive material 17 of the adhesive tape 15 are selected from the materials having refractive index approximately equal to glass constituting the cathode ray tube assembly 2, the reflected light is reduced more efficiently.

In the cathode ray tube 1 according to the above-described embodiments, since the light-absorption material layer 10 is formed to cover the outside surface of the cathode ray tube assembly 2 from the funnel portion 4 to the skirt portion 3B of the panel portion 3 and the flame portion of the front surface 3A other than the effective screen area 8 of the panel portion 3 of the cathode ray tube assembly 2, light entered the cathode ray tube assembly 2 is absorbed into the light-absorption material layer 10.

Further, since the refractive index of the light absorption layer 10, that is, the coating film 11, or the tape base material 16 or the adhesive material 17 of the adhesive tape 15 is set approximately equal to refractive index of the cathode ray tube assembly 2, for example that of glass, the reflectance on the interface between the light absorption material 10 and the cathode ray tube assembly 2 is made extremely small and the reflected light on the interface is virtually reduced to nothing.

Accordingly, reflectance of the incident light is reduced and reflected light is absorbed into the light absorption layer 10, whereby the beams of stray light reflected multiple times in glass constituting the cathode ray tube assembly 2 (numeral 21 in FIG. 1) and those of stray light reflected on the cathode ray tube assembly 2 (numeral 22 in FIG. 1) are reduced.

Consequently, deterioration of contrast of image caused by the above-described stray light is reduced.

Further, since reflected light is absorbed into the light absorption layer 10, light leaked from the cathode ray tube 1 to the outside is also reduced.

Accordingly, even when a plurality of cathode ray tubes 1 are arranged close to each other, deterioration of contrast of image caused by the leaked light is prevented.

Specifically, according to the embodiments of the present invention, contrast of image of the cathode ray tube 1 is improved and the picture having high contrast and excellent quality is obtained.

Furthermore, when the cathode ray tube 1 according to the embodiment of the present invention shown in FIG. 1 is employed as the cathode ray tube for use in a projection type display (projector), although not shown in the figure, there is arranged a container with a concave lens attached, in which coolant is sealed on, for example, the front surface 3A side of the panel portion of the cathode ray tube 1 and a lens is further disposed in front of the container, thereby constructing a liquid-cooled cathode ray tube.

According to the above-described construction, the image fed by the cathode ray tube 1 is projected on a screen of the projection type display, for example.

Consequently, the projection type display is constructed using the cathode ray tube 1 according to the embodiments, whereby the projection type display having high contrast and excellent image quality is obtained.

Further, the area in which the light-absorption material layer 10 is formed to cover the outside surface of the cathode ray tube assembly 2 is not limited to that in the embodiments of the present invention.

In the present invention, the light-absorption material layer 10 is required to be formed at least on the skirt portion 3B of the panel portion 3, and the light-absorption material layer 10 may be formed on the funnel portion 4 and the front surface 3A of the panel portion 3 other than the effective screen area 8 as need arises.

The present invention is not limited to the embodiments described above, and can take various modifications without departing from the gist of the present invention.

According to the above-described cathode ray tube of the present invention, contrast of image affected by stray light and leaked light is improved to obtain the excellent picture with high contrast.

1. (amended) In a cathode ray tube comprising a cathode ray tube assembly in which a panel portion, funnel portion, and neck portion are formed of glass, the cathode ray tube characterized in that:
a light-absorption material layer is formed at least on the outside surface of a skirt portion of the panel portion of said cathode ray tube assembly; and
a refractive index of said light-absorption material layer is set approximately equal to the refractive index of said cathode ray tube assembly to decrease reflectance of light on an interface, thereby reducing stray light reflected in said cathode ray tube assembly and improving the quality of image contrast.

2. A cathode ray tube according to claim 1, wherein
said light-absorption material layer is formed of a coating film.

3. A cathode ray tube according to claim 1, wherein
said light-absorption material layer is formed of adhesive tape, and tape base material or adhesive material of said adhesive tape has a refractive index approximately equal to the refractive index of said cathode ray tube assembly.

4. (Amended) A cathode ray tube according to claim 1, wherein said light-absorption layer is further formed on the outside surface from said panel portion other than an effective screen area to said funnel portion.

5. (Deleted)
